(19) United States
(12) Patent Application Publication
(10) Pub. No.: US 2022/0212635 A1
(43) Pub. Date: Jul. 7, 2022

(54) METHOD AND CONTROL DEVICE FOR AUTOMATICALLY CLEANING A MOTOR VEHICLE

(71) Applicant: Volkswagen Aktiengesellschaft, Wolfsburg (DE)

(72) Inventors: Stephan Kurzhals, Schöningen (DE); Stefan Lux, Adenbüttel (DE)

(21) Appl. No.: 17/611,385

(22) PCT Filed: May 8, 2020
(86) PCT No.: PCT/EP2020/062809

§ 371 Date: Nov. 15, 2021

(30) Foreign Application Priority Data
May 15, 2019 (DE) 10 2019 207 036.1

(51) Int. Cl. B60S 3/04; G06Q 10/02; B60W 30/06

(52) U.S. Cl. CPC B60S 3/04; B60W 30/06; G06Q 10/02

(57) ABSTRACT

Technologies and techniques for automatically cleaning a motor vehicle. A need for cleaning is identified via a control device. A cleaning device is selected and booking a cleaning time in the selected cleaning device is performed, based on at least one criterion. The motor vehicle may be autonomously maneuvered to the selected cleaning device via the control device, such that the motor vehicle reaches the cleaning device, at the booked cleaning time at the latest. The motor vehicle may be autonomously maneuvered to a predefined parking location via the control device, after the cleaning of the motor vehicle has ended, wherein a sensor device of the motor vehicle determines a degree of soiling of the motor vehicle and the control device identifies the need for cleaning on this basis, and/or a user specification of a person relating to the need for cleaning is detected by the control device and the control device identifies the need for cleaning on this basis.

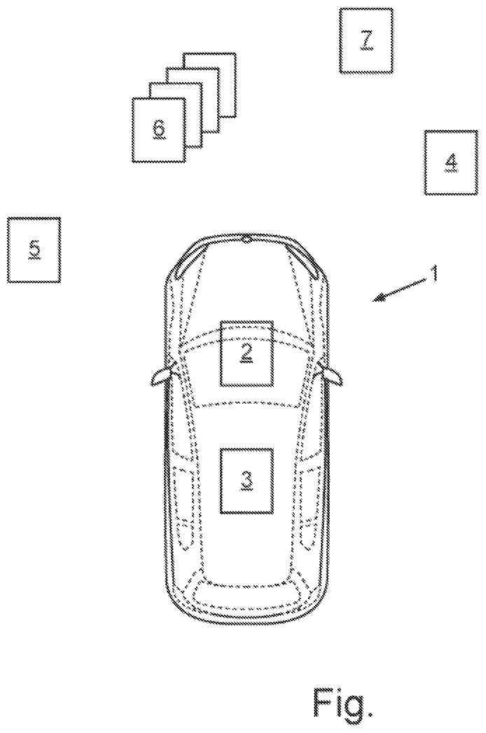

### RELATED APPLICATIONS

The present application claims priority to International Patent App. No. PCT/EP2020/062809 to Kurzhals et al., filed May 8, 2020, which further claims priority to German Pat. App. No. 10 2019 207 036.1 filed May 15, 2019, the contents of each being incorporated by reference in their entirety herein.

### TECHNICAL FIELD

The present disclosure relates to technologies and techniques for a control device for automatically cleaning a motor vehicle. The present disclosure furthermore relates to a motor vehicle comprising such a control device.

### BACKGROUND

During use, motor vehicles are subject to soiling. This can result in both visual and technical impairment. The latter can be the case, for example, when the motor vehicle is exposed to road salt during the winter, which can result in corrosion on the motor vehicle.

US 2018/0082494 A1 shows a method for automatically servicing an autonomously driving motor vehicle. The motor vehicle can independently schedule a service appointment and, for example, autonomously drive to a repair shop. It is also possible for the motor vehicle to autonomously drive to a car wash.

US 2015/0348335 A1 likewise shows a method in which an autonomously driving motor vehicle automatically undergoes service work. This can also include that the motor vehicle is cleaned automatically. For this purpose, the motor vehicle can drive to a car wash automatically. Thereafter, the motor vehicle can, again autonomously, drive to a garage of a vehicle owner.

### SUMMARY

Aspects of the present disclosure are related to providing a solution by which a motor vehicle can be automatically cleaned, in a particularly needs-based manner.

Certain aspects are achieved by the features recited in the independent claims. Further possible embodiments of the present disclosure are described in the dependent claims.

In some examples, a method is disclosed for automatically cleaning a motor vehicle identifies a need for cleaning by means of a control device of the motor vehicle. The control device selects a cleaning facility and books a cleaning appointment in the selected cleaning facility based on at least one criterion after the control device has identified the need for cleaning. The motor vehicle is autonomously maneuvered to the selected cleaning facility by means of the control device, so that the motor vehicle reaches the cleaning facility at the latest by the booked cleaning appointment, where the motor vehicle is cleaned. After the cleaning of the motor vehicle has been completed, the motor vehicle is autonomously maneuvered to a predefined drop-off location by means of the control device. The motor vehicle can be configured to drive autonomously, and more particularly without a vehicle occupant having to be present inside the motor vehicle; that is, it can be operated in a driving mode according to SAE Level 5 autonomy. The control device can in part also be implemented offboard, in particular with respect to the processing and interpretation of the sensor values, that is, in a vehicle-external processor system or computer network outside the vehicle.

In some examples, a sensor device is disclosed, which may be located external relative to the vehicle, wherein the sensor device ascertains a degree of soiling of the motor vehicle, and wherein the control device identifies the need for cleaning based on the degree of soiling ascertained by means of the vehicle-external sensor device. The vehicle-external sensor device can be attached to another motor vehicle, for example. It is also possible for the vehicle-external sensor device to include a camera, for example, in a private parking space of an owner of the motor vehicle. The degree of soiling of the motor vehicle can thus be established very well by means of the vehicle-external sensor device, so that the control device can likewise identify the need for cleaning based on the degree of soiling ascertained by means of the vehicle-external sensor device. The control device can be configured to carry out Car2X communications so as to receive and evaluate data from the vehicle-external sensor device regarding the degree of soiling of the motor vehicle. For example, those areas of the motor vehicle can be assessed by means of the vehicle-external sensor device regarding the soiling thereof that are only poorly visible or not visible at all by means of the vehicle-side sensor device. In this way, the need for cleaning of the motor vehicle can be ascertained in a manner that is particularly consistent with existing need, even if the internal vehicle sensor device would not have established the presence of soiling at all in certain areas of the motor vehicle.

The control device according to the present disclosure for a motor vehicle is configured to carry out the method according to the present disclosure or a possible embodiment of the method according to the present disclosure. Possible embodiments of the method according to the present disclosure are to be regarded as possible embodiments of the control device, wherein the control device in particular comprises for carrying out the method steps.

The motor vehicle according to the present disclosure comprises the control device according to the present disclosure or a possible embodiment of the control device according to the present disclosure.

### BRIEF DESCRIPTION OF THE DRAWINGS

Additional possible advantages, features and details of the present disclosure will be described based on the following FIGURE. The features and feature combinations mentioned above in the description, and the features and feature combinations shown hereafter in the description of the FIGURE and/or shown only in the FIGURE, can be used not only in the respectively indicated combination but also in other combinations, or alone, without departing from the scope of the present disclosure.

In the only FIGURE, the drawing shows a schematic illustration of a motor vehicle comprising a control device which is designed to control an automatic cleaning process of the motor vehicle.

### DETAILED DESCRIPTION

On some examples, a method according to the present disclosure is characterized in that a sensor device of the motor vehicle ascertains a degree of soiling of the motor vehicle, wherein the control device identifies the need for cleaning based on the ascertained degree of soiling. As an alternative or in addition, it can be provided that a user specification by a person regarding the need for cleaning is detected by means of the control device, wherein the control device identifies the need for cleaning based on the detected user specification.

The motor vehicle is thus configured to drive autonomously, wherein the control device can control the autonomous maneuvering of the motor vehicle. For example, the motor vehicle can be equipped with one or more GPS sensors, a navigation device and environment sensors, so that the motor vehicle can be maneuvered autonomously to the selected cleaning facility. The cleaning of the motor vehicle can comprise exterior cleaning and/or interior cleaning of the motor vehicle. The cleaning facility that was selected and booked can additionally be configured to carry out the cleaning process of the motor vehicle fully automatically. If the vehicle, for example, has to drive through the cleaning facility for the cleaning process, the control device can, for example, maneuver the motor vehicle through the cleaning facility. As an alternative or in addition, it can also be provided that the cleaning facility can maneuver the motor vehicle through the cleaning facility.

The predefined drop-off location does not have to be the same location as the one from which the motor vehicle started to drive to the cleaning facility. If the motor vehicle is washed at night, for example, the predefined drop-off location can be the same location as the one from where the motor vehicle started to drive to the cleaning facility, for example, from a garage or a parking space of a vehicle user. The aforementioned person can predefine the predefined drop-off location, for example, so that the motor vehicle can pick up the person at the predefined location after the automatic cleaning process, wherein this location does not have to be the same location as the one from where the motor vehicle started to drive to the cleaning facility.

In some examples, the control device and/or the motor vehicle include a communications unit, which is configured to carry out a selection process and a booking process of the cleaning facility by means of a corresponding communication, either directly or indirectly with the cleaning facility in question. This can take place, for example, via WLAN and/or a mobile communications network. Since the motor vehicle is configured to drive autonomously, and more particularly without the need for a driver to be present inside the motor vehicle, the motor vehicle can be automatically cleaned in a particularly simple manner. For example, the motor vehicle drives autonomously to the cleaning facility during planned idle times, and it is likewise guided autonomously through the cleaning process. The aforementioned sensor device of the motor vehicle can ascertain the degree of soiling of the motor vehicle, wherein the control device can independently identify the need for cleaning based on corresponding data characterizing the degree of soiling. As an alternative or in addition, the aforementioned person can predefine the user specification regarding the need for cleaning, wherein the control device can recognize the need for cleaning based on the detected user specification. For example, the user specification can be entered from inside the motor vehicle itself via a suitable interface, via a smart phone, on a computer, or the like.

Due to the fact that the vehicle-side sensor device can ascertain the degree of soiling of the motor vehicle, it is possible for the motor vehicle to be automatically cleaned in a particularly needs-based manner. Since, as an alternative or in addition, the user specification entered by the person regarding the need for cleaning can be detected, it is possible to meet the specifications of the person regarding the need for cleaning even if, based on the degree of soiling ascertained by means of the vehicle-side sensor device, the control device did not recognize or ascertain a need for cleaning at that time. By means of the method according to the present disclosure, it is possible to carry out the automatic cleaning of the motor vehicle as a fully automated process. In this way, it is possible to automatically clean the motor vehicle in a particularly needs-based and simple manner.

In some examples, the sensor device may include a front camera of the motor vehicle by means of which the degree of soiling of the motor vehicle is ascertained. Since the motor vehicle is configured to drive autonomously, it includes a plurality of sensors anyhow for environment recognition. One of these sensors can be the aforementioned front camera of the motor vehicle by means of which the degree of soiling of the motor vehicle can be ascertained. As an alternative or in addition to the front camera, the sensor device can also include optical sensors, which are configured to ascertain the degree of soiling of the motor vehicle. In particular when a plurality of sensors of the motor vehicle is used, which are arranged in different positions of the motor vehicle, the degree of soiling of the motor vehicle can be ascertained particularly well, so that, for example, purely localized soiling of the motor vehicle can also be reliably ascertained.

In some examples, the cleaning of the motor vehicle may be billed to a person automatically. The aforementioned person, who can be the vehicle owner and/or vehicle proprietor, for example, can register for this purpose with a central registration service, or the like, for example, where the person can have stored his or her user data and, for example, his or her banking information, including a direct debit authorization. In this way, it is possible to bill the person for cleaning the motor vehicle particularly conveniently in an automated manner.

In some examples, the selection of the cleaning facility and booking of the cleaning appointment are carried out after an authorization has first taken place. The authorization can, for example, be provided by the same person who predefines the user specification regarding the need for cleaning. Due to the fact that the action of the selection and booking of the cleaning facility only takes place if an authorization has taken place first, it can be ensured that the motor vehicle is not cleaned against the wishes of a vehicle owner, for example. The authorization can be provided as a standing instruction, for example, until it is revoked. As an alternative, it also possible, for example, for the authorization to be requested at the latest for completing the booking process, that is, for booking the appointment. This yields the advantage, among other things, that the person in question is always notified when the motor vehicle is to autonomously drive to a cleaning facility for cleaning the motor vehicle.

In some examples, a user specification regarding the need for cleaning may include a point in time by when the motor vehicle is to be cleaned. A driver of the motor vehicle can thus predefine, for example, that the motor vehicle is to be cleaned by Saturday afternoon because the person wishes to take the motor vehicle on an excursion and desires for the motor vehicle to be particularly clean at that time. The selection of the cleaning facility and booking of the appointment in question are then carried out while taking the predefined point in time into consideration to ensure that the cleaned motor vehicle is available at the predefined drop-off location by the predefined point in time.

In some examples, the user specification regarding the need for cleaning may include a time interval for cleaning the motor vehicle on a regular basis. A vehicle owner can thus predefine, for example, that the motor vehicle is to be cleaned every two weeks. Taking this time interval into consideration, the control device can select the cleaning facility and book the cleaning appointment, so that the predefined time interval is adhered to. In the event that the motor vehicle is soiled prematurely within the time interval, it can also be provided that the motor vehicle undergo an additionally cleaning run, for example, only after the vehicle owner has given his or her consent. In the event that another cleaning of the motor vehicle is not necessary within the time interval, for example, because this absence of a need was ascertained by the sensor device of the motor vehicle, it can also be provided that another such cleaning of the motor vehicle is dispensed with until the next time that such an interval has started or elapsed. In this way, it can be ensured that, on the one hand, the user specification as it relates to the time interval is respected, and, on the other hand, that the motor vehicle is not cleaned unnecessarily frequently.

In some examples, the selection of the cleaning facility and booking of the cleaning appointment at the selected cleaning facility may be carried out, based on at least one of the following criteria:

the motor vehicle is not needed for the duration of the cleaning period, including a trip to the cleaning facility and a return trip from the cleaning facility to the predefined location;
a likelihood that parking is available for the motor vehicle at the predefined drop-off location is to have at least one predefined value;
costs for the cleaning process and/or for a trip to the cleaning facility and a return trip to the drop-off location are to be minimized; and
a predefined intermediate stop is to be located along the way to the cleaning facility.

The control device can thus take planned idle times of the motor vehicle into consideration so as to carry out, as a function thereof, the selection and booking of the cleaning facility in question. In the process, both the actual duration for the cleaning process and the duration for the trip and return trip can be taken into consideration. For example, the control device can access an electronic calendar of a user of the motor vehicle so as to establish when the motor vehicle will not be needed. As an alternative or in addition, it is also possible, for example, for the control device to access historical data, based on which the control device can estimate when the motor vehicle will very likely not be moved. As an alternative or in addition, it is possible for the control device to take into consideration how likely it is that parking will be available for the motor vehicle at the predefined drop-off location, wherein the control device, as a function thereof, selects the cleaning facility and books the cleaning appointment in such a way that the likelihood that parking will be available at the predefined drop-off location has at least one predefined value.

For example, it is conceivable that a user of the motor vehicle does not have access to dedicated private parking and, for example, that he parks the motor vehicle in the area of a residential parking zone at night. The control device can access data that characterizes at what times parking will likely be available within the residential parking zone. As a function thereof, the control device can book the cleaning appointment in such a way that the motor vehicle, when driving back to the predefined drop-off location, will very likely find available parking. The control device can also take costs for the cleaning process and/or costs for a trip to the cleaning facility, as well as a return trip to the predefined drop-off location into consideration, whereby it can select the cleaning appointment as well as the cleaning facility in such a way that these costs will be minimized. The control device can thus, for example, query multiple cleaning facilities in an automated manner, and it can compare prices for different cleaning appointments, as well as for different cleaning facilities. As an alternative or in addition, the control device can also take into consideration the respective distances to the cleaning facilities and any trip costs associated therewith.

In this way, the control device can plan the cleaning process in such a way that the associated costs are minimized. In addition, it is also possible for the control device to select the cleaning facility and/or the cleaning appointment in such a way that a predefined intermediate stop along the way to the cleaning facility is planned for a given time. For example, it is conceivable that a vehicle user would like to drive autonomously or by himself or herself to work using the motor vehicle, wherein the place of work is the intermediate stop. The driver will not need the motor vehicle for a certain length of time after his or her arrival at the place of work, so that the control device, for example, can select a suitable cleaning facility in the vicinity of the place of work. It is also possible, for example, for a user of the motor vehicle, who prefers to clean the inside of his or her motor vehicle manually, to be able to select via the control device a suitable cleaning facility where manual cleaning of the interior of the motor vehicle is possible as an intermediate stop. Thereafter, the motor vehicle can be moved, for example, autonomously, to the cleaning facility, where the outside of the motor vehicle is cleaned. It is also possible, for example, for the user to predefine an arbitrary number of intermediate stops, which the control device can take into consideration when selecting the cleaning facility and booking the cleaning appointment. Among other things, this helps to minimize the necessary distance to the cleaning facility in question.

Turning to the FIGURE, motor vehicle 1, which is designed and configured to drive autonomously, comprises a control device 2. The control device 2 is designed to identify a need for cleaning with respect to the motor vehicle 1. The motor vehicle 1 comprises a vehicle-side sensor device 3, which can comprise a front camera, for example, by means of which a degree of soiling of the motor vehicle 1 can be ascertained. The sensor device 3 can transmit data characterizing the degree of soiling of the motor vehicle 1 to the control device 2. The control device 2 can identify the need for cleaning based on the ascertained degree of soiling. Moreover, a person 4 can manually predefine a need for cleaning with respect to the motor vehicle 1, wherein the control device 2 is configured to detect this user specification. For example, the control device 2 can comprise a communications device, which is not shown here, that is configured to detect the user specification, for example, via WLAN and/or a mobile communications link. This can be necessary, for example, if the person 4 inputs the user specification via his or her smart phone or, for example, via a PC. As an alternative, the person 4 can also directly input the need for cleaning, for example, via a vehicle-side user interface, which is not shown here.

A vehicle-external sensor device 5 is only shown schematically here. This vehicle-external sensor device 5 can be configured to detect a degree of soiling of the motor vehicle 1, and to transmit data in this regard to the control device 2, for example, likewise via WLAN and/or a mobile communications link. The vehicle-external sensor device 5 can, for example, comprise a camera at a private parking space where the motor vehicle 1 is parked on a regular basis. The vehicle-external sensor device 5 can, for example, also comprise a camera at another motor vehicle 1 which can ascertain the degree of soiling of the motor vehicle 1 while passing the motor vehicle 1 and transmit any related data to the control device 2.

After the control device 2 has identified the need for cleaning, it selects a cleaning facility 6, preferably from a plurality of cleaning facilities 6, and books a cleaning appointment at the selected cleaning facility 6 based on at least one criterion. For example, the control device 2 can take into consideration that the motor vehicle 1 is not needed for the duration of the cleaning period, including a trip to the cleaning facility 6 and a return trip from the cleaning facility 6. The control device 2 can also take into consideration the likelihood that parking will be available for the motor vehicle 1 at a predefined drop-off location 7 where the motor vehicle 1 is to be dropped off after the cleaning process. In the process, the control device can select the cleaning appointment in such a way that the likelihood that the aforementioned parking is available has at least one predefined value. If the motor vehicle 1 is parked, for example, on a regular basis in a residential parking zone, that is not in a private parking spot, the control device 2 can select the cleaning appointment in such a way that a parking space will indeed be found in the residential parking zone with a very high likelihood, when the motor vehicle 1 is moved autonomously to this zone after the cleaning process.

The control device 2 can, for example, also consider the costs for the cleaning process and/or for a trip to the cleaning facility 6 and for a return trip back from the cleaning facility 6, wherein the control device 2 can be designed to select the cleaning facility and the cleaning appointment in such a way that these costs are minimized. For example, the control device 2 can also consider a predefined intermediate stop along the way to the cleaning facility 6 in question, and to select the cleaning appointment and the cleaning facility 6 in question in such a way that the predefined intermediate stop along the way to the cleaning facility 6 occurs at a predefined time.

The control device 2 may be configured to autonomously maneuver the motor vehicle 1 to the selected cleaning facility 6, so that the motor vehicle reaches the cleaning facility 6 in question at the latest by the time of the booked cleaning appointment, where the motor vehicle 1 is cleaned. The cleaning facility 6 in question can be configured to clean the motor vehicle 1 both on the inside and on the outside fully autonomously. After the cleaning of the motor vehicle 1 has been completed, the control device 2 maneuvers the motor vehicle 1 to the predefined drop-off location 7. For example, the person 4 can predefine this drop-off location 7. If the person 4 does not make any specification, the drop-off location 7 can also be the location from where the motor vehicle 1 had started toward the cleaning facility 6. If the motor vehicle 1 is cleaned during the night, it may be provided, for example, that the motor vehicle 1 is simply maneuvered back to a garage of the person 4. As an alternative, including at night, it may be provided, for example, that the person 4 is located at a restaurant, wherein in that case the predefined drop-off location 7 can be the restaurant. During the day, the predefined drop-off location 7 can also be a place of work of the person 4, for example.

The selection of the cleaning facility 6 in question and the booking of the cleaning appointment may be carried out only if an authorization has been given first, for example, by the person 4. The authorization can be a standing authorization, for example, until it is revoked. As an alternative or in addition, it is also possible, for example, for the control device 2 to request authorization from the person 4 prior to booking the cleaning appointment and proceed with the booking only if the authorization is given. As was already mentioned above, it is possible for the person 4 to provide a user specification with respect to the need for cleaning. This user specification can include a point in time, for example, by which the person 4 desires to have the motor vehicle 1 cleaned. If the person 4 would like to take a weekend trip using the motor vehicle 1, for example, and desires to have the motor vehicle 1 cleaned both on the inside and on the outside, the person 4 can set a corresponding user specification which the control device 2 receives and takes into consideration. The user specification regarding the need for cleaning can also include a time interval, for example, according to which the motor vehicle 1 is to be cleaned on a regular basis. The control device 2 can take this into consideration as well.

Overall, the described method and the described control device 2 provide a solution by which the motor vehicle 1 can be automatically cleaned in a manner that is particularly consistent with the given need for cleaning. In the process, an availability of the motor vehicle 1 can be taken into consideration and additionally any capacities of surrounding cleaning facilities 6, any costs associated with the cleaning process, any distances to be traveled to the cleaning facility 6 by means of the motor vehicle 1, and the like, for example. The motor vehicle 1 can thus be cleaned fully automatically in a needs-based manner. Moreover, it is also possible not only for the cleaning process to be identified and carried out automatically, but also for the cleaning process in question to be billed automatically. For example, the person 4 can register with one or more service providers and, for example, store direct debit authorizations in each case. In this way, it is possible for the person 4 to be billed very conveniently for the automatic cleaning process in question.

### LIST OF REFERENCE SIGNS

1 motor vehicle

2 control device of the motor vehicle

3 sensor device of the motor vehicle

4 person

5 vehicle-external sensor device

6 cleaning facilities

7 drop-off location

1-10. (canceled)

11. A method for automatically cleaning a motor vehicle, comprising:
ascertaining a degree of soiling of the motor vehicle based on a sensor device of the motor vehicle;
processing the degree of soiling in a control device;
processing a user specification regarding the need for cleaning in the control device;
selecting, via the control device, a predetermined time period for a cleaning facility based on at least one criterion and the processed degree of soiling and user specification;
autonomously maneuvering the motor vehicle via the control device to the selected cleaning facility at the predetermined time period; and
autonomously maneuvering the motor vehicle to a predefined drop-off location via the control device, after autonomously maneuvering the motor vehicle to the selected cleaning facility.

12. The method according to claim 11, wherein the sensor device comprises a front camera of the motor vehicle in which the degree of soiling of the motor vehicle is ascertained.

13. The method according to claim 11, further comprising executing an authorization process prior to selecting the predetermined time period for the cleaning facility.

14. The method according to claim 11, wherein the user specification comprises a point in time by which the motor vehicle is to be cleaned.

15. The method according to claim 11, wherein the user specification comprises a time interval, according to which the motor vehicle is to be cleaned on a regular basis.

16. The method according to claim 11, wherein the at least one criterion comprises one or more of:
a time period in which the motor vehicle is not needed for the duration of the cleaning, including a trip to the cleaning facility and a return trip from the cleaning facility to the predefined location;
a likelihood that parking will be available for the motor vehicle at the predefined drop-off location has at least one predefined value;
costs for the cleaning process and/or for a trip to the cleaning facility; and
a predefined intermediate stop located along the way to the cleaning facility.

17. The method according to claim 11, further comprising ascertaining a degree of soiling of the motor vehicle based on a vehicle-external sensor device, and determining a need for cleaning, via the control device, based on the degree of soiling ascertained via the vehicle-external sensor device.

18. The method according to claim 11, further comprising receiving billing data automatically for the cleaning of the motor vehicle.

19. A system for automatically cleaning a motor vehicle, comprising:
a sensor device; and
a control device, wherein the sensor device and control device are configured to:
ascertain a degree of soiling of the motor vehicle;
process the degree of soiling;
process a user specification regarding the need for cleaning;
select a predetermined time period for a cleaning facility based on at least one criterion and the processed degree of soiling and user specification;
autonomously maneuver the motor vehicle to the selected cleaning facility at the predetermined time period; and
autonomously maneuvering the motor vehicle to a predefined drop-off location after autonomously maneuvering the motor vehicle to the selected cleaning facility.

20. The system according to claim 19, wherein the sensor device comprises a front camera of the motor vehicle in which the degree of soiling of the motor vehicle is ascertained.

21. The system according to claim 19, wherein the control device is configured to execute an authorization process prior to selecting the predetermined time period for the cleaning facility.

22. The system according to claim 19, wherein the user specification comprises a point in time by which the motor vehicle is to be cleaned.

23. The system according to claim 19, wherein the user specification comprises a time interval, according to which the motor vehicle is to be cleaned on a regular basis.

24. The system according to claim 19, wherein the at least one criterion comprises one or more of:
a time period in which the motor vehicle is not needed for the duration of the cleaning, including a trip to the cleaning facility and a return trip from the cleaning facility to the predefined location;
a likelihood that parking will be available for the motor vehicle at the predefined drop-off location has at least one predefined value;
costs for the cleaning process and/or for a trip to the cleaning facility; and
a predefined intermediate stop located along the way to the cleaning facility.

25. The system according to claim 19, wherein the control device is configured to ascertain a degree of soiling of the motor vehicle based on a vehicle-external sensor device, and determine a need for cleaning, via the control device, based on the degree of soiling ascertained via the vehicle-external sensor device.

27. The system according to claim 19, wherein the control device is configured to receive billing data automatically for the cleaning of the motor vehicle.

28. A system for automatically cleaning a motor vehicle, comprising:
a sensor device comprising a front camera; and
a control device, wherein the sensor device and control device are configured to:
ascertain a degree of soiling of the motor vehicle;
process the degree of soiling;
process a user specification regarding the need for cleaning;
execute an authorization process;
select a predetermined time period for a cleaning facility based on at least one criterion and the processed degree of soiling and user specification;
autonomously maneuver the motor vehicle to the selected cleaning facility at the predetermined time period; and
autonomously maneuvering the motor vehicle to a predefined drop-off location after autonomously maneuvering the motor vehicle to the selected cleaning facility.

29. The system according to claim 28, wherein the user specification comprises one of (i) a point in time by which the motor vehicle is to be cleaned, or (ii) a time interval, according to which the motor vehicle is to be cleaned on a regular basis.

30. The system according to claim 28, wherein the at least one criterion comprises one or more of:
a time period in which the motor vehicle is not needed for the duration of the cleaning, including a trip to the cleaning facility and a return trip from the cleaning facility to the predefined location;
a likelihood that parking will be available for the motor vehicle at the predefined drop-off location has at least one predefined value;
costs for the cleaning process and/or for a trip to the cleaning facility; and
a predefined intermediate stop located along the way to the cleaning facility.
